(19) United States
(12) Patent Application Publication
(10) Pub. No.: US 2017/0195456 A1
(43) Pub. Date: Jul. 6, 2017

(54) TRAFFIC CONTROL IN A COMMUNICATION NETWORK

(71) Applicant: Telefonaktiebolaget L M Ericsson (publ)

(72) Inventors: Peter Ohlen, Stockholm (SE); Ahmad Rostami, Solna (SE)

(21) Appl. No.: 14/896,361

(22) PCT Filed: Nov. 30, 2015
(86) PCT No.: PCT/EP2015/078012

§ 371 Date: Dec. 4, 2015

(51) Int. Cl. H04L 29/08; H04W 16/22; H04W 72/12; H04W 16/18; H04W 28/02; H04L 29/06; H04W 16/10

(52) U.S. Cl. CPC H04L 67/322; H04L 63/10; H04W 16/22; H04W 16/10; H04W 16/18; H04W 28/0231; H04W 28/0257; H04W 72/1252; H04W 72/1257

(57) ABSTRACT

A method for traffic control is disclosed for a communication network comprising a controller node operationally connectable to a plurality of network nodes. The controller node acquires one or more current communication scenario parameters provided to the controller node by each of one or more first network nodes out of the plurality of network nodes. The controller node predicts (based on the acquired current communication scenario parameters) one or more future communication scenarios, wherein each predicted communication scenario comprises one or more predicted communication scenario parameters for each of one or more second network nodes out of the plurality of network nodes. Furthermore, the controller node determines (for at least one selected communication scenario out of the predicted communication scenarios) a traffic control operation for each of one or more third network nodes out of the plurality of network nodes. The controller node transmits, to each of the one or more third network nodes, a message indicative of the determined traffic control operation and the predicted communication scenario parameters for each of the selected communication scenarios. Each of the one or more third network nodes may compare one or more subsequent current communication scenario parameters to the predicted communication scenario parameters, and (if a match is detected for any of the selected communication scenarios) perform the corresponding determined traffic control operation. Corresponding computer program product, arrangements, network node, controller node and communication network are also disclosed.

### TECHNICAL FIELD

The present invention relates generally to the field of communication networks. More particularly, it relates to traffic control in communication networks.

### BACKGROUND

In wireless communication networks (e.g. microwave networks and other networks utilizing free space for communication), the conditions of a communication link may, for example, be impacted by weather conditions (e.g. degraded by rain, fog, snow, etc.) and/or by other obstacles in the signal path (e.g. flocks of birds, temporary constructions, large vehicles or construction machinery, etc.).

Using small cells in a wireless communication network typically entails that more backhaul will be needed compared to a large (e.g. macro) cell deployment. This is true also for dense urban deployments. To accomplish this increased backhaul requirements, a partially meshed network approach may be considered and potentially attractive technologies to enable a quick and cost-effective deployment include point-to-point microwave, other wireless options, and line-of-sight optical.

In a partially meshed network, the traffic of a link with degraded conditions can be re-routed to other links that are not (or at least not equally) impacted by degraded conditions. Furthermore, each link may be subject to adaptation of transmission parameters (e.g. transmission format, modulation, coding, transmit power, etc.) on that particular link based on the current conditions. Even which such approaches, disturbances in the communication may occur due to temporarily degraded link conditions.

Therefore, there is a need for improved traffic control in communication networks.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof.

It is an object of some embodiments to solve or mitigate at least some of the above or other disadvantages.

According to a first aspect, this is achieved by a method for traffic control of a controller node of a communication network, wherein the controller node is operationally connectable to a plurality of network nodes of the communication network.

The method of the first aspect may for example be performed in a single controller node or in a plurality of controller nodes (where each controller node may perform one or mode of the steps of the method).

The method comprises acquiring (for each of one or more first network nodes out of the plurality of network nodes) one or more current communication scenario parameters and predicting (based on the acquired current communication scenario parameters) one or more future communication scenarios, wherein each predicted communication scenario comprises one or more predicted communication scenario parameters for each of one or more second network nodes out of the plurality of network nodes.

The method also comprises determining (for at least one selected communication scenario out of the predicted communication scenarios) a traffic control operation for each of one or more third network nodes out of the plurality of network nodes and transmitting (to each of the one or more third network nodes) a message indicative of the determined traffic control operation and the predicted communication scenario parameters for each of the selected communication scenarios.

The collection of first network nodes may comprise a subset of the plurality of network nodes or all of the plurality of network nodes.

The collection of second network nodes may comprise a subset of the plurality of network nodes or all of the plurality of network nodes. The collection of second network nodes may coincide or overlap with the collection of first network nodes. For example, the collection of second network nodes may be a subset of the collection of first network nodes, or vice versa.

The collection of third network nodes may comprise a subset of the plurality of network nodes or all of the plurality of network nodes. The collection of third network nodes may coincide or with overlap the collection of first network nodes. For example, the collection of third network nodes may be a subset of the collection of first network nodes, or vice versa. Furthermore, the collection of third network nodes may coincide or with overlap the collection of second network nodes. For example, the collection of third network nodes may be a subset of the collection of second network nodes, or vice versa.

The traffic control operation may comprise any suitable traffic control operation relating to traffic control at a network node.

The predicted communication scenario parameters may be for matching subsequent current communication scenarios to the selected communication scenarios (and the corresponding determined traffic control operation).

In the message, the determined traffic control operation may be indicated by parameter settings for transmission/reception/relaying of communication.

The parameters for transmission/reception/relaying of communication and the scenario parameters may generally coincide, overlap, or differ.

According to some embodiments, at least one of the current communication scenario parameters and the predicted communication scenario parameters may comprise at least one of a traffic load and a link status throughput, signal-to-interference ratio, etc.). The current communication scenario parameters and the predicted communication scenario parameters may, alternatively or additionally, comprise node specific parameters (e.g. state of reception/transmission buffers).

Generally, any suitable parameters may be used for defining the various scenarios and for defining the traffic control operations.

In some embodiment, predicting the one or more future communication scenarios may be further based on correlation statistics between communication scenario parameters and subsequent communication scenario parameters.

The method may, in such embodiments, further comprise acquiring (for at least one of the second network nodes) one or more subsequent current communication scenario parameters, and updating the correlation statistics based on the current communication scenario parameters and the subsequent current communication scenario parameters.

When the current communication scenario parameters refer to parameters of a first communication scenario, the subsequent current communication scenario parameters may (typically) refer to parameters of a second communication scenario which is subsequent to the first communication scenario. According to some embodiments, the method may further comprise selecting the at least one communication scenario based on a probability of each of the predicted communication scenarios. For example, the most probable among the predicted communication scenarios may be selected. The probabilities may be derived based on the correlation statistics.

A second aspect is a method for traffic control performed in a network node of a communication network, wherein the network node is operationally connectable to a controller node of the communication network.

The method comprises providing (to the controller node) one or more current communication scenario parameters relating to the network node and receiving (from the controller node) a message indicative of a determined traffic control operation and predicted communication scenario parameters for each of at least one predicated communication scenario, wherein the predicted communication scenario is predicted by the controller node based on acquired current communication scenario parameters relating to a plurality of network nodes of the communication network.

According to some embodiments, the method may further comprise comparing one or more subsequent current communication scenario parameters to the predicted communication scenario parameters.

If a match is detected between the subsequent current communication scenario parameters and the predicted communication scenario parameters for any of the selected communication scenarios, the method may comprise performing the corresponding determined traffic control operation.

If no match is detected, the method may comprise reverting to a default traffic control procedure.

In some embodiments, the method may further comprise providing (to the controller node) the one or more subsequent current communication scenario parameters for updating of correlation statistics between communication scenario parameters and subsequent communication scenario parameters.

A third aspect is a computer program product comprising a computer readable medium, having thereon a computer program comprising program instructions. The computer program is loadable into a data-processing unit and adapted to cause execution of the method according to any of the first and second aspects when the computer program is run by the data-processing unit.

According to a fourth aspect, a traffic control arrangement is provided for a controller node of a communication network, wherein the controller node is operationally connectable to a plurality of network nodes of the communication network.

The arrangement comprises a controller node controller adapted to cause acquisition (e.g. by a receiver) of one or more current communication scenario parameters for each of one or more first network nodes out of the plurality of network nodes and prediction (e.g. by a predictor) of one or more future communication scenarios based on the acquired current communication scenario parameters, wherein each predicted communication scenario comprises one or more predicted communication scenario parameters for each of one or more second network nodes out of the plurality of network nodes.

The controller node controller is also adapted to cause determination (e.g. by a determiner) of a traffic control operation for each of one or more third network nodes out of the plurality of network nodes, for at least one selected (e.g. by a selector) communication scenario out of the predicted communication scenarios, and transmission (e.g. by a transmitter) of a message indicative of the determined traffic control operation and the predicted communication scenario parameters for each of the selected communication scenarios to each of the one or more third network nodes.

In some embodiments, the controller node controller may be further adapted to cause the prediction of the one or more future communication scenarios based also on correlation statistics between communication scenario parameters and subsequent communication scenario parameters. The arrangement may further comprise a database adapted to store the correlation statistics. The controller node controller may be further adapted to cause acquisition (for at least one of the second network nodes) of one or more subsequent current communication scenario parameters and updating of the correlation statistics based on the current communication scenario parameters and the subsequent current communication scenario parameters.

A fifth aspect is a controller node comprising the arrangement according to the fourth aspect.

A sixth aspect is a traffic control arrangement for a network node of a communication network, wherein the network node is operationally connectable to a controller node of the communication network.

The arrangement comprises a network node controller adapted to cause provision (e.g. by a transmitter), to the controller node, of one or more current communication scenario parameters relating to the network node and reception (e.g. by a receiver), from the controller node, of a message indicative of a determined traffic control operation and predicted communication scenario parameters for each of at least one predicated communication scenario, wherein the predicted communication scenario is predicted by the controller node based on acquired current communication scenario parameters relating to a plurality of network nodes of the communication network.

A seventh aspect is a network node comprising the arrangement according to the sixth aspect.

An eighth aspect is a communication network comprising a controller node according to the fifth aspect and a plurality of network nodes according to the seventh aspect.

Generally, any of the first through eighth aspects may additionally have features identical with or corresponding to any of the various features as explained above for any of the other aspects.

An advantage of some embodiments is that improved traffic control in communication networks is achieved.

Another advantage of some embodiments is that dynamic traffic control in communication networks is achieved.

Another advantage of some embodiments is that the traffic control may be implemented quickly (reduced traffic control reaction time) when one or more communication links experience degraded conditions. This may be achieved by predicting plausible future scenarios and pre-configuring the relevant network nodes with traffic control settings for the plausible future scenarios.

According to some embodiments, a meshed (or partially meshed) free space communication network is dynamically optimized to maximize the overall throughput in the network. The controller node and the network nodes may support a pre-provisioning scheme that can handle a high dynamicity in the network state by a combination of central and local traffic-dependent decisions. The network may thus be pre-provisioned for the most probable scenarios prior to their occurrence.

### BRIEF DESCRIPTION OF THE DRAWINGS

Further objects, features and advantages will appear from the following detailed description of embodiments, with reference being made to the accompanying drawings, in which:

FIG. 1 is a schematic drawing illustrating a communication network where some embodiments may be applicable;

FIG. 2 is a combined flowchart and signaling diagram illustrating example method steps and signaling according to some embodiments;

FIG. 3 is a block diagram illustrating example arrangements according to some embodiments; and

FIG. 4 is a schematic drawing illustratinga computer readable medium according to some embodiments.

### DETAILED DESCRIPTION

Routing will be used as an example of traffic control in the following description. However, this is not to be construed as limiting. Contrarily, the traffic control may comprise any suitable traffic control (e.g. routing, marking traffic, prioritization, packet dropping, traffic shaping, etc.).

In the following, embodiments will be described where routing control is applied in a proactive manner. A controller node prepares network nodes for routing based on one or more predicted scenarios, such that the routing can be accomplished quickly if one of the predicted scenarios occurs. Thus, the routing reaction time (or routing delay) may be reduced compared to routing control schemes where these principles are not applied. Embodiments may be particularly useful under variable link conditions.

As will be elaborated on in the following, a method for routing control is disclosed for a communication network comprising a controller node operationally connectable to a plurality of network nodes.

The controller node acquires one or more current communication scenario parameters provided to the controller node by each of one or more first network nodes out of the plurality of network nodes.

The controller node predicts (based on the acquired current communication scenario parameters) one or more future communication scenarios, wherein each predicted communication scenario comprises one or more predicted communication scenario parameters for each of one or more second network nodes out of the plurality of network nodes.

Furthermore, the controller node determines (for at least one selected communication scenario out of the predicted communication scenarios) a routing operation for each of one or more third network nodes out of the plurality of network nodes.

The controller node transmits, to each of the one or more third network nodes, a message indicative of the determined routing operation and the predicted communication scenario parameters for each of the selected communication scenarios.

Each of the one or more third network nodes may compare one or more subsequent current communication scenario parameters to the predicted communication scenario parameters, and (if a match is detected for any of the selected communication scenarios) perform the corresponding determined routing operation.

Corresponding computer program product, arrangements, network node, controller node and communication network are also disclosed.

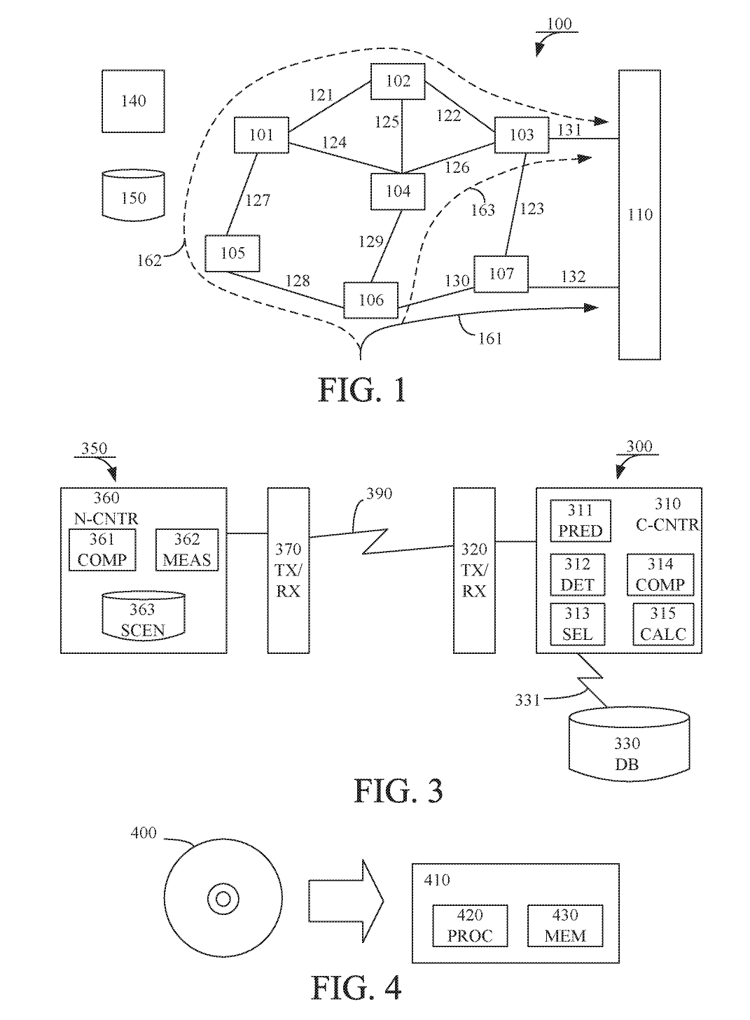

FIG. 1 schematically illustrates an example communication network 100 where some embodiments may be applicable. The communication network 100 comprises a plurality of network nodes 101, 102, 103, 104, 105, 106, 107, a controller node 140 and a database 150.

The network nodes 101, 102, 103, 104, 105, 106, 107 are connected to each other in a meshed network, either by direct links 121, 122, 123, 124, 124, 125, 126, 127, 128, 129, 130 or by a chain of links via network nodes. For example, network node 101 is connected to network node 102 via direct link 121, to network node 104 via direct link 124, and to network node 105 via direct link 127, while it is connected to network node 107—for example—via network nodes 105 and 106 by the chain of links provided by links 127, 128, 130.

The network nodes 103 and 107 are also directly connected to a further part of the communication network 110 via the interfaces 131 and 132, respectively. The further part of the communication network 110 may refer to any suitable network construction (with regard to function, implementation, topology, etc.), such as—but not limited to—a core network, a wired network, a wireless network, a meshed network, a microwave network, an optical network, an Internet protocol (IP) network, an Ethernet network, etc.

The links 121, 122, 123, 124, 124, 125, 126, 127, 128, 129, 130 are typically—but not necessatily—wireless links (e.g. microwave links). At least some of the links 121, 122, 123, 124, 124, 125, 126, 127, 128, 129, 130 are subject to variable conditions (e.g. path loss, fading, signal-to-interference ratio, etc.). Such variable conditions may, for example, be due to one or more of weather conditions, obstacles in the signal path, congestion and traffic load. To optimize network performance (e.g. capacity, throughput, etc.) under the variable conditions routing may be applied. In the example communication network 100 the routing is controlled by the controller node 140, which is operationally connectable to the plurality of network nodes 101, 102, 103, 104, 105, 106, 107.

As will be elaborated on in the following, the routing may be supported by correlation statistics stored in the database 150 associated with the controller node 140. Generally, the database 150 may be comprised in or external to the controller node 140.

In a routing example illustrated in FIG. 1, transmission of data is ongoing from network node 106 to the further part of the communication network 110. The direct link 130 is the (signal-wise) shortest path to reach the further part of the communication network 110 from network node 106 via network node 107 and interface 132, and the transmission of data initially uses this path as illustrated by 161. If the link 130, for some reason, suffers from degraded conditions, routing to another path from network node 106 to the further part of the communication network 110 may be beneficial, e.g. any of the paths 162 and 163 illustrated in FIG. 1. The following description will exemplify how such routing may be controlled in an efficient manner by the controller node 140 according to some embodiments.

Rerouting traffic dynamically and based on varying link conditions may be crucial for efficient resource utilization in wireless transport networks such as the example network 100. A difficulty in relation to routing is that the link conditions may change dynamically, and it is typically not known how the link conditions (e.g. a performance degradation) will develop in the near future (e.g. over the next few seconds). For example, performance degradation may remain unchanged, degrade further, spread to nearby links, or regress (i.e. the link conditions improve). Despite of these unknown dynamics, one typically wants to keep the network at a configuration that is as close to optimum as possible. However, a reactive routing control mechanism applied to the dynamic situation may lead to poor network operation, in particular in terms of resource utilization. Furthermore, delays in the routing process may be experienced. To address this, embodiments provide for a routing preparation process where at least some routing decisions can be made ahead of time.

The controller node (e.g. 140 of FIG. 1) may, for example, be realized through software defined networking (SDN) approaches. Typically, some functions of the controller node may include collection of up-to-date information regarding availability of resources from the network (realized in the form of current communication scenario parameters), dynamical allocation of resources in the network (realized in the form of routing operations for selected communication scenarios), and enforcement of the allocation decisions in the network (realized by pre-configuring the network nodes for the selected communication scenarios).

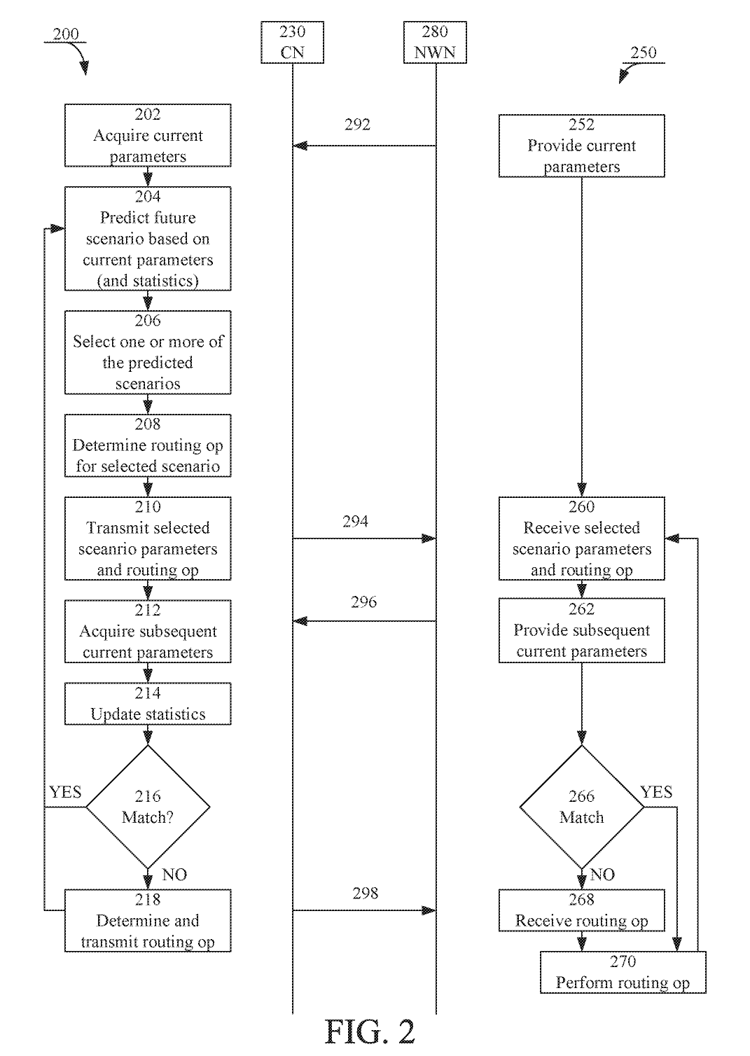

FIG. 2 illustrate an example method 200 performed by a controller node (CN) 230 of a communication network, an example method 250 performed by a network node (NWN) 280 of a communication network and example signaling between the controller node 230 and the network node 280 according to some embodiments, wherein the controller node is operationally connected to a plurality of network nodes comprising the network node 280. The controller node 230 may, for example, be the controller node 140 of FIG. 1 and the network node 280 may, for example, be any, some or all of the network nodes 101, 102, 103, 104, 105, 106, 107 of FIG. 1.

In step 252, the network node 280 (and typically also some or all of the other network nodes operationally connected to the controller node) provides one or more current communication scenario parameters 292, which are acquired (e.g. received) by the controller node 230 in step 202. The network nodes providing one or more current communication scenario parameters to the controller node are termed first network nodes herein.

In step 204, the controller node 230 predicts one or more future communication scenarios based on the acquired current communication scenario parameters.

For example, if the acquired current communication parameters for links in a particular geographical area indicates that the links are experiencing degraded performance, it may be reasonable to assume that the degradation is due to weather conditions in that geographical area and that there is a possibility that the weather conditions may spread or move to (some) neighboring geographical areas in the near future, which spreading or moving translates into predictions regarding one or more future communication scenarios.

Each predicted communication scenario comprises one or more predicted communication scenario parameters (similar to the current communication scenario parameters) for each network node affected by the predicted communication scenario (e.g. the network node 280 and typically also some or all of the other network nodes operationally connected to the controller node). The network nodes affected by a predicted communication scenario are termed second network nodes herein.

In step 206, one or more (e.g. all) of the predicted scenarios are selected for pre-configuration in the relevant network nodes. For example, the most probable out of the predicted communication scenario(s) may be selected. The network nodes relevant for a selected communication scenario are termed third network nodes herein.

For example, if a weather condition in the area where the communication network is deployed usually spreads from west to east, this course of events may be regarded as most probable and the predicted scenario(s) implementing such a development may be selected.

In some embodiments, the prediction of communication scenarios in step 204 and/or the selection of communication scenarios in step 206 may be based on correlation statistics between communication scenario parameters and subsequent communication scenario parameters. The correlation statistics may be stored in a database (e.g. the database 150 of FIG. 1).

For example, the correlation statistics may indicate for each of a number of current communication scenarios how probable one or more future communication scenarios are. The correlation statistics may be based on historical scenario sequences and may or may not differ depending on geographical location and/or other prerequisites.

The correlation statistics may be used in the prediction and selection process to determine which communication scenarios to consider.

In a first example, the prediction may comprise using all, or the most probable ones, of the future communication scenarios indicated by the correlation statistics for the current communication scenario, and the selection may be according to any suitable principle.

In a second example, the prediction may be according to any suitable principle and the selection may comprise selecting the most probable ones of the predicted communication scenarios where the probability is indicated by the correlation statistics for the current communication scenario.

In a third example, the prediction and selection steps are merged and the selected communication scenarios are all, or the most probable ones, of the future communication scenarios indicated by the correlation statistics for the current communication scenario.

In some embodiments, the correlation statistics may be dynamically updated based on newly appearing scenario sequences as will be illustrated by step 214.

In step 208, a routing operation is determined for each selected communication scenario and for each network node relevant for the selected communication scenario. A routing operation may comprise any suitable routing operation such as, for example, not changing communication settings, seizing reception/transmission, switching link for reception and/or transmission, etc. In some embodiments, each subsequent communication scenario indicated by the correlation statistics may have an associated set of routing operations stored together with the correlation statistics.

A message is transmitted by the controller node for each selected communication scenario and received by each network node relevant for the selected communication scenario, wherein the message is indicative of the determined routing operation and the predicted communication scenario parameters for the selected communication scenario. This is illustrated in FIG. 2 by the message 294 being transmitted by the controller node in step 210 and received by the network node 280 in step 260.

The messages 294 enable the network nodes to prepare for probable routing operations; the routing operations that are determined for the selected communication scenario(s). Thus, if any of the selected communication scenarios occur, the network node can directly implement the appropriate routing operation without having to await further instructions from the controller node 230. This provides for improved routing control by reduced routing reaction time.

This is illustrated by steps 266 and 270 performed by the network node 280. Thus, when some time (which can be static or dynamic depending on the implementation) has passed and the current communication scenario parameters of step 252 have transformed into subsequent current communication scenario parameters (which may coincide, overlap or differ from the current communication scenario parameters), the subsequent current communication scenario parameters are compared to the predicted communication scenario parameters for each of the selected communication scenarios relevant for the network node 280.

If a match is detected (YES-path out of step 266) between the subsequent current communication scenario parameters and the predicted communication scenario parameters for any of the selected communication scenarios, then the determined routing operation corresponding to that selected communication scenario is performed in step 270, and the method 250 returns to step 260.

If no match is detected (NO-path out of step 266) between the subsequent current communication scenario parameters and the predicted communication scenario parameters for any of the selected communication scenarios, then reverting to a default routing algorithm may be applied.

For example, the subsequent current communication scenario parameters may be provided to, and acquired by, the controller node as illustrated by steps 262, 212 and transmission 296. As illustrated by step 218, the controller node may determine (based on the subsequent current communication scenario parameters) and transmit a routing operation 298 to the network node, which receives the routing operation in step 268 and applies it in step 270.

The subsequent current communication scenario parameters may be provided to the controller node after no match has been found in the comparison of parameters by the network node. This has the advantage of reduced signaling.

Alternatively, the subsequent current communication scenario parameters may be provided to, and acquired by, the controller node before the comparison of parameters in step 266 as illustrated by steps 262, 212 and transmission 296 in FIG. 2. This has the advantage that the subsequent current communication scenario parameters are always provided to the controller node 230 regardless of the outcome of the comparison in step 266, and may be used in analogy with the current communication scenario parameters 292 provided in step 252 and acquired in step 202 for iteration of the process.

When the subsequent current communication scenario parameters are provided to the controller node before the comparison of parameters in step 266, the controller node may perform a comparison between the subsequent current communication scenario parameters and the predicted communication scenario parameters for each of the selected communication scenarios relevant for the network node 280 (compare with step 266).

If a match is detected (YES-path out of step 216), then the network node already has a pre-configured routing operation corresponding to that selected communication scenario and the method 200 returns to step 204.

If no match is detected (NO-path out of step 216), then, in step 218, the controller node determines (based on the subsequent current communication scenario parameters) and transmits a routing operation 298 to the network node according to the default routing algorithm before returning to step 204.

The controller node may also use correlation between current communication scenario parameters and subsequent current communication scenario parameters for updating of the correlation statistics as illustrated in step 214. For example, if no match was detected, the newly discovered scenario sequence may be added to the correlation statistics.

It should be noted that steps 212, 214, 216 and 218 as well as steps 262, 266, 268 and 270 may be implemented in any suitable order and that the order illustrated in FIG. 2 is merely an example.

Generally, any communication scenario parameters referred to herein may comprise suitable parameters that may be used for defining the various scenarios. The parameters may coincide, overlap, or differ for different network nodes and/or different scenarios. For example, the communication scenario parameters may comprise at least one of a traffic load, a link status, an error rate, a link capacity, and a link bandwidth.

Also generally, any routing operation may be determined by any suitable communication setting parameters. The parameters may coincide, overlap, or differ for different routing operations and/or different network nodes.

FIG. 3 is a block diagram illustrating example arrangements 300, 350 for a controller node and a network node, respectively, according to some embodiments. The controller node may, for example, be the controller node 140 of FIG. 1 or the controller node 230 of FIG. 2, and the network node may, for example, be any, some or all of the network nodes 101, 102, 103, 104, 105, 106, 107 of FIG. 1 or the network node 280 of FIG. 2.

The arrangement 300 for the controller node comprises a controller node controller (C-CNTR) 310 and a transmitter and a receiver, here illustrated as a transceiver (TX/RX) 320. The arrangement 300 can access a database (DB) 330 via association 331. As mentioned before, the database may be comprised in or external to the controller node.

The arrangement 350 for the network node comprises a network node controller (N-CNTR) 360 and a transmitter and a receiver, here illustrated as a transceiver (TX/RX) 370.

The controller node is operationally connected to the network node via the transceivers 320, 370 and the connection 390. Similar operational connections exist between the controller node and other network nodes.

The controller node controller 310 may be adapted to cause performing of the method 200 described in FIG. 2. In some embodiments, the controller node controller 310 may comprise a SDN controller.

Current communication scenario parameters for the network node(s) may be acquired by the receiver part of the transceiver 320 (compare with steps 202 and 212 of FIG. 2). Prediction and selection of communication scenarios based on the current communication scenario parameters may be achieved, respectively, by a predictor (PRED) 311 and a selector (SEL 313) of the controller node controller 310, possibly using correlation statistics of the database 330 (compare with steps 204 and 206 of FIG. 2). Determination of network node routing operations for each selected communication scenario may be achieved by a determiner (DET) 312 of the controller node controller 310 (compare with step 208 of FIG. 2). The routing operations and predicted communication scenario parameters for each selected communication scenario may be indicated by a message transmitted by the transmitter part of the transceiver 320 (compare with step 210 of FIG. 2).

When subsequent current communication scenario parameters are acquired, a comparator (COMP) 314 of the controller node controller 310 may be used to determine whether a routing operation should be determined and transmitted according to a default routing approach (compare with steps 216 and 218 of FIG. 2).

Updating of the database 330 may be caused by the controller node controller 310 based on received sequences of current communication scenario parameters (compare with step 214 of FIG. 2). A calculator (CALC) 315 of the controller node controller 310 may be used to determine how the correlation statistics should be updated. The calculator may, for example, use any suitable probability calculation algorithm.

The network node controller 360 may be adapted to cause performing of the method 250 described in FIG. 2.

Current communication scenario parameters for the network node may be determined by a measuring unit (MEAS) 362 of the network node controller 360, and provided to the controller node by the transmitter part of the transceiver 370 (compare with steps 252 and 262 of FIG. 2). The routing operations and predicted communication scenario parameters for each selected communication scenario may be indicated by a message received by the receiver part of the transceiver 370 (compare with step 260 of FIG. 2), as well as routing operations of a default routing algorithm (compare with step 268 of FIG. 2). The routing operations and predicted communication scenario parameters for each selected communication scenario may be temporarily stored in a scenario register or memory (SUN) 363.

When subsequent current communication scenario parameters are determined, a comparator (COMP) 361 of the network node controller 360 may be used to determine whether a temporarily stored routing operation or a routing operation according to a default routing approach should be used (compare with steps 266 and 270 of FIG. 2).

The described embodiments and their equivalents may be realized in software or hardware or a combination thereof They may be performed by general-purpose circuits associated with or integral to a communication device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of this disclosure.

Embodiments may appear within an electronic apparatus (such as a network node or a controller node) comprising circuity/logic or performing methods according to any of the embodiments. The electronic apparatus may, for example, be a communication node, a switching node, a packet switch, an IP router, an Ethernet switch, a microwave network node, a base station or a base station controller.

According to some embodiments, a computer program product comprises a computer readable medium such as, for example, a USB-stick, a plug-in card, an embedded drive, or a read-only memory (ROM) such as the CD-ROM 400 illustrated in FIG. 4. The computer readable medium may have stored thereon a computer program comprising program instructions. The computer program may be loadable into a data-processing unit (PROCs 420, which may, for example, be comprised in a network node or controller node 410. When loaded into the data-processing unit, the computer program may be stored in a memory (MEM) 430 associated with or integral to the data-processing unit. According to some embodiments, the computer program may, when loaded into and run by the data-processing unit, cause the data-processing unit to execute method steps according to, for example, the methods shown in FIG. 2.

Reference has been made herein to various embodiments. However, a person skilled in the art would recognize numerous variations to the described embodiments that would still fall within the scope of the claims. For example, the method embodiments described herein describes example methods through method steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the partition of functional blocks into particular units is by no means limiting. Contrarily, these partitions are merely examples. Functional blocks described herein as one unit may be split into two or more units. In the same manner, functional blocks that are described herein as being implemented as two or more units may be implemented as a single unit without departing from the scope of the claims.

Hence, it should be understood that the details of the described embodiments are merely for illustrative purpose and by no means limiting. Instead, all variations that fall within the range of the claims are intended to be embraced therein.

1: A method for traffic control of a controller node of a communication network, wherein the controller node is operationally connectable to a plurality of network nodes of the communication network, the method comprising:
acquiring, for each of one or more first network nodes out of the plurality of network nodes, one or more current communication scenario parameters;
predicting, based on the acquired current communication scenario parameters, one or more future communication scenarios, wherein each predicted communication scenario comprises one or more predicted communication scenario parameters for each of one or more second network nodes out of the plurality of network nodes;
determining, for at least one selected communication scenario out of the predicted communication scenarios, a traffic control operation for each of one or more third network nodes out of the plurality of network nodes; and
transmitting, to each of the one or more third network nodes, a message indicative of the determined traffic control operation and the predicted communication scenario parameters for each of the selected communication scenarios.

2: The method of claim 1, wherein predicting the one or more future communication scenarios is further based on correlation statistics between communication scenario parameters and subsequent communication scenario parameters.

3: The method of claim 2 further comprising:
acquiring, for at least one of the second network nodes, one or more subsequent current communication scenario parameters; and
updating the correlation statistics based on the current communication scenario parameters and the subsequent current communication scenario parameters.

4: The method of claim 1, further comprising selecting the at least one communication scenario based on a probability of each of the predicted communication scenarios.

5: A method for traffic control performed in a network node of a communication network, wherein the network node is operationally connectable to a controller node of the communication network, the method comprising:
providing, to the controller node, one or more current communication scenario parameters relating to the network node; and
receiving, from the controller node, a message indicative of a determined traffic control operation and predicted communication scenario parameters for each of at least one predicated communication scenario,
wherein the predicted communication scenario is predicted by the controller node based on acquired current communication scenario parameters relating to a plurality of network nodes of the communication network.

6: The method of claim 5 further comprising:
comparing one or more subsequent current communication scenario parameters to the predicted communication scenario parameters; and
if a match is detected between the subsequent current communication scenario parameters and the predicted communication scenario parameters for any of the selected communication scenarios, performing the corresponding determined traffic control operation.

7: The method of claim 6 further comprising:
providing, to the controller node, the one or more subsequent current communication scenario parameters for updating of correlation statistics between communication scenario parameters and subsequent communication scenario parameters.

8: The method of claim 1, wherein at least one of the current communication scenario parameters and the predicted communication scenario parameters comprises at least one of a traffic load and a link status.

9: A nontransitory computer readable medium, having thereon a computer program comprising program instructions, the computer program being loadable into a data-processing unit and adapted to cause execution of a method when the computer program is run by the data-processing unit, wherein the method is for traffic control of a controller node of a communication network, wherein the controller node is operationally connectable to a plurality of network nodes of the communication network, and wherein the method comprises:
acquiring, for each of one or more first network nodes out of the plurality of network nodes, one or more current communication scenario parameters;
predicting, based on the acquired current communication scenario parameters, one or more future communication scenarios, wherein each predicted communication scenario comprises one or more predicted communication scenario parameters for each of one or more second network nodes out of the plurality of network nodes;
determining, for at least one selected communication scenario out of the predicted communication scenarios, a traffic control operation for each of one or more third network nodes out of the plurality of network nodes; and
transmitting, to each of the one or more third network nodes, a message indicative of the determined traffic control operation and the predicted communication scenario parameters for each of the selected communication scenarios.

10: A traffic control arrangement for a controller node of a communication network, wherein the controller node is operationally connectable to a plurality of network nodes of the communication network, the arrangement comprising a controller node controller adapted to cause:
acquisition, for each of one or more first network nodes out of the plurality of network nodes, of one or more current communication scenario parameters;
prediction, based on the acquired current communication scenario parameters, of one or more future communication scenarios, wherein each predicted communication scenario comprises one or more predicted communication scenario parameters for each of one or more second network nodes out of the plurality of network nodes;
determination, for at least one selected communication scenario out of the predicted communication scenarios, of a traffic control operation for each of one or more third network nodes out of the plurality of network nodes; and
transmission, to each of the one or more third network nodes, of a message indicative of the determined traffic control operation and the predicted communication scenario parameters for each of the selected communication scenarios.

11: The arrangement of claim 10 wherein the controller node controller is further adapted to cause the prediction of the one or more future communication scenarios based also on correlation statistics between communication scenario parameters and subsequent communication scenario parameters.

12: The arrangement of claim 11 further comprising a database adapted to store the correlation statistics.

13: The arrangement of claim 12 wherein the controller node controller is further adapted to cause:
acquisition, for at least one of the second network nodes, of one or more subsequent current communication scenario parameters; and
updating of the correlation statistics based on the current communication scenario parameters and the subsequent current communication scenario parameters.

14: The arrangement of claim 10, wherein the controller node controller is further adapted to cause selection of the at least one communication scenario based on a probability of each of the predicted communication scenarios.

15: The arrangement of claim 10, wherein at least one of the current communication scenario parameters and the predicted communication scenario parameters comprises at least one of a traffic load and a link status.

16: A controller node comprising the arrangement according to claim 10.

17: A traffic control arrangement for a network node of a communication network, wherein the network node is operationally connectable to a controller node of the communication network, the arrangement comprising a network node controller adapted to cause:
provision, to the controller node, of one or more current communication scenario parameters relating to the network node; and
reception, from the controller node, of a message indicative of a determined traffic control operation and predicted communication scenario parameters for each of at least one predicated communication scenario,
wherein the predicted communication scenario is predicted by the controller node based on acquired current communication scenario parameters relating to a plurality of network nodes of the communication network.

18: The arrangement of claim 17 wherein the network node controller is further adapted to cause:
comparison of one or more subsequent current communication scenario parameters to the predicted communication scenario parameters; and
if a match is detected between the subsequent current communication scenario parameters and the predicted communication scenario parameters for any of the selected communication scenarios, performing of the corresponding determined traffic control operation.

19: The arrangement of claim 18 wherein the network node controller of the traffic control arrangement for a network node is further adapted to cause provision, to the controller node, of the one or more subsequent current communication scenario parameters for updating of correlation statistics between communication scenario parameters and subsequent communication scenario parameters.

20: The arrangement of claim 17, wherein at least one of the current communication scenario parameters and the predicted communication scenario parameters comprises at least one of a traffic load and a link status.

21: A network node comprising the arrangement according to claim 17.

22: A communication network comprising a controller node according to claim 16 and a plurality of network nodes, wherein each of the network nodes comprises a network node controller adapted to cause:
provision, to the controller node, of one or more current communication scenario parameters relating to the network node; and
reception, from the controller node, of a message indicative of a determined traffic control operation and predicted communication scenario parameters for each of at least one predicated communication scenario,
wherein the predicted communication scenario is predicted by the controller node based on acquired current communication scenario parameters relating to a plurality of network nodes of the communication network.
